(19) United States
(12) Patent Application Publication
(10) Pub. No.: US 2014/0117047 A1
(43) Pub. Date: May 1, 2014

(54) PRESSURE RELIEF FOR ADHESIVE DISPENSING SYSTEM

(71) Applicant: GRACO MINNESOTA INC., Minneapolis, MN (US)

(72) Inventors: Daniel P. Ross, Maplewood, MN (US); Joseph E. Tix, Hastings, MN (US); Matthew R. Theisen, Woodbury, MN (US); Nicholas K. Studt, Hudson, WI (US)

(73) Assignee: GRACO MINNESOTA INC., Minneapolis, MN (US)

(21) Appl. No.: 13/705,702

(22) Filed: Dec. 5, 2012

Related U.S. Application Data
(60) Provisional application No. 61/718,310, filed on Oct. 25, 2012.

(51) Int. Cl. B05C 9/14; F04B 49/22

(52) U.S. Cl. CPC B05C 9/14; F04B 49/22
USPC 222/146.2; 222/334; 417/280

(57) ABSTRACT

A hot melt system is described which includes a container of hot melt pellets, a melter, a feed system, a pump, and a dispensing system. A pressure relief system is built around the pump, which may redirect liquefied adhesive from the pump outlet to the pump inlet.

### BACKGROUND

The present disclosure relates generally to systems for dispensing hot melt adhesive. More particularly, the present disclosure relates to pressure relief systems that relieve pump pressure at system shutdown.

Hot melt dispensing systems are typically used in manufacturing assembly lines to automatically dispense an adhesive used in the construction of packaging materials such as boxes, cartons and the like. Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure.

### SUMMARY

A hot melt system has a container, a melter, a feed system, a dispensing system, a pump, and a pressure relief system. The melter is capable of heating hot melt pellets that are fed from the container. The pump pressurizes the liquid from the melter and passes it to the dispensing system. The dispensing system can then dispense the liquefied adhesive. The pressure relief system is capable of rerouting liquefied adhesive from an outlet of the pump to and inlet of the pump.

### BRIEF DESCRIPTION OF THE DRAWINGS

FIG. 1 is a schematic view of a hot melt adhesive system.

FIG. 2 is a simplified schematic view of a system for dispensing hot melt adhesive showing a pressure relief mechanism.

FIG. 3 is a cross-sectional view of a dispenser and pump of FIG. 2 showing a pressure relief mechanism interconnected with the pump.

### DETAILED DESCRIPTION

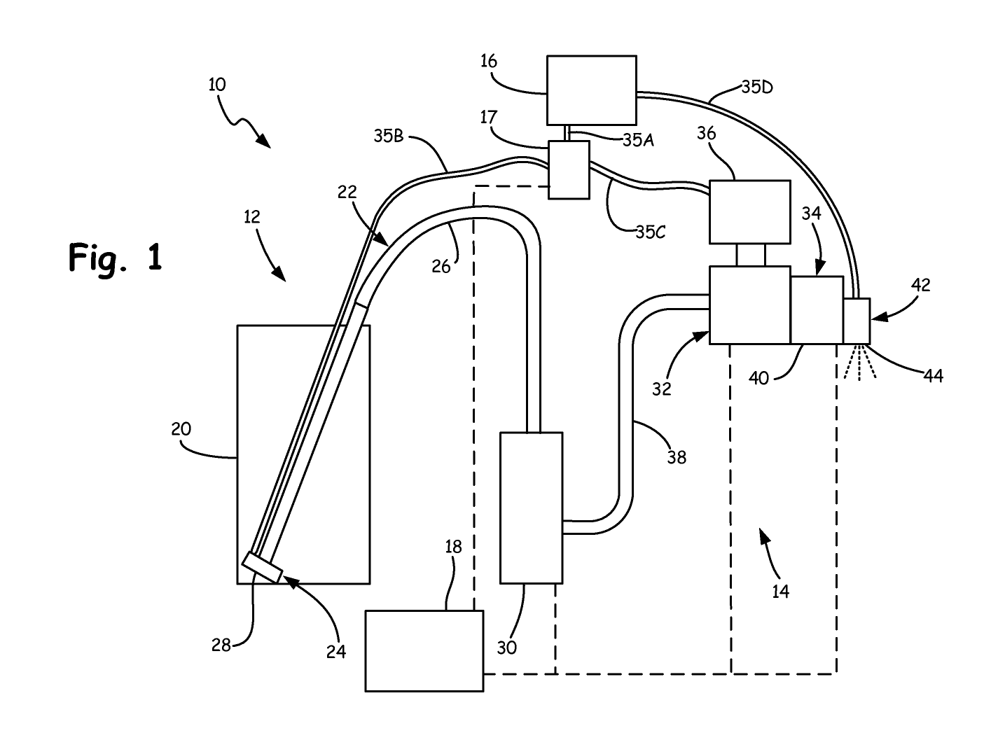

FIG. 1 is a schematic view of system 10, which is a system for dispensing hot melt adhesive. System 10 includes cold section 12, hot section 14, air source 16, air control valve 17, and controller 18. In the embodiment shown in FIG. 1, cold section 12 includes container 20 and feed assembly 22, which includes vacuum assembly 24, feed hose 26, and inlet 28. In the embodiment shown in FIG. 1, hot section 14 includes melt system 30, pump 32, and dispenser 34. Air source 16 is a source of compressed air supplied to components of system 10 in both cold section 12 and hot section 14. Air control valve 17 is connected to air source 16 via air hose 35A, and selectively controls air flow from air source 16 through air hose 35B to vacuum assembly 24 and through air hose 35C to motor 36 of pump 32. Air hose 35D connects air source 16 to dispenser 34, bypassing air control valve 17. Controller 18 is connected in communication with various components of system 10, such as air control valve 17, melt system 30, pump 32, and/or dispenser 34, for controlling operation of system 10.

Components of cold section 12 can be operated at room temperature, without being heated. Container 20 can be a hopper for containing a quantity of solid adhesive pellets for use by system 10. Suitable adhesives can include, for example, a thermoplastic polymer glue such as ethylene vinyl acetate (EVA) or metallocene. Feed assembly 22 connects container 20 to hot section 14 for delivering the solid adhesive pellets from container 20 to hot section 14. Feed assembly 22 includes vacuum assembly 24 and feed hose 26. Vacuum assembly 24 is positioned in container 20. Compressed air from air source 16 and air control valve 17 is delivered to vacuum assembly 24 to create a vacuum, inducing flow of solid adhesive pellets into inlet 28 of vacuum assembly 24 and then through feed hose 26 to hot section 14. Feed hose 26 is a tube or other passage sized with a diameter substantially larger than that of the solid adhesive pellets to allow the solid adhesive pellets to flow freely through feed hose 26. Feed hose 26 connects vacuum assembly 24 to hot section 14.

Solid adhesive pellets are delivered from feed hose 26 to melt system 30. Melt system 30 can include a container (not shown) and resistive heating elements (not shown) for melting the solid adhesive pellets to form a hot melt adhesive in liquid form. Melt system 30 can be sized to have a relatively small adhesive volume, for example about 0.5 liters, and configured to melt solid adhesive pellets in a relatively short period of time. Pump 32 is driven by motor 36 to pump hot melt adhesive from melt system 30, through supply hose 38, to dispenser 34. Motor 36 can be an air motor driven by pulses of compressed air from air source 16 and air control valve 17. Pump 32 can be a linear displacement pump driven by motor 36. In the illustrated embodiment, dispenser 34 includes manifold 40 and module 42. Hot melt adhesive from pump 32 is received in manifold 40 and dispensed via module 42. Dispenser 34 can selectively discharge hot melt adhesive whereby the hot melt adhesive is sprayed out outlet 44 of module 42 onto an object, such as a package, a case, or another object benefiting from hot melt adhesive dispensed by system 10. Module 42 can be one of multiple modules that are part of dispenser 34. In an alternative embodiment, dispenser 34 can have a different configuration, such as a handheld gun-type dispenser. Some or all of the components in hot section 14, including melt system 30, pump 32, supply hose 38, and dispenser 34, can be heated to keep the hot melt adhesive in a liquid state throughout hot section 14 during the dispensing process.

System 10 can be part of an industrial process, for example, for packaging and sealing cardboard packages and/or cases of packages. In alternative embodiments, system 10 can be modified as necessary for a particular industrial process application. For example, in one embodiment (not shown), pump 32 can be separated from melt system 30 and instead attached to dispenser 34. Supply hose 38 can then connect melt system 30 to pump 32.

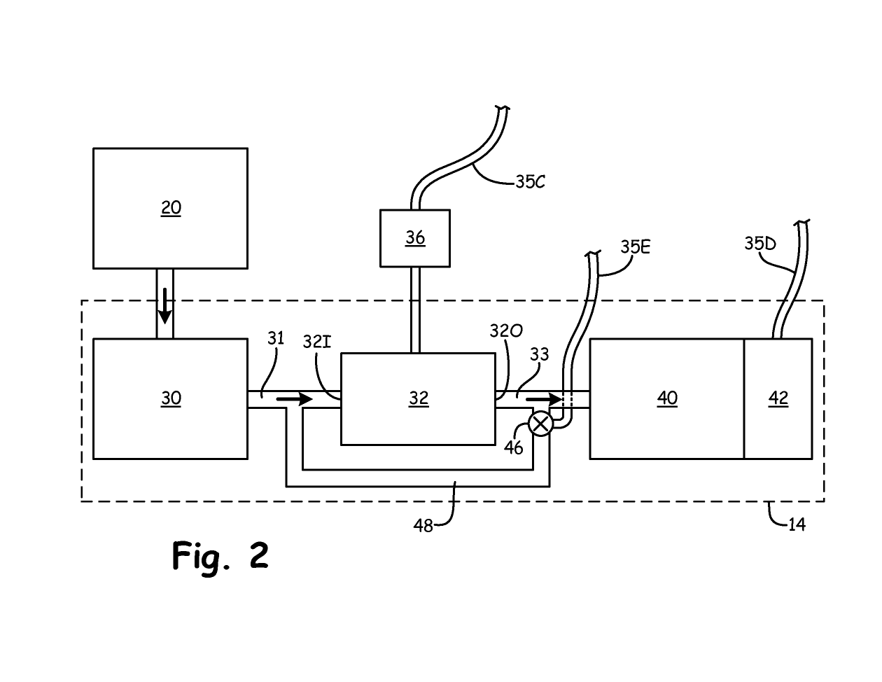

FIG. 2 is a simplified flow diagram illustrating the path of liquefied adhesive through system 10. FIG. 2 shows a portion of system 10, including container 20, motor 36, and hot section 14. Hot section 14 includes melt system 30, pump 32, and dispenser 34, which includes manifold 40 and module 42. Pressure relief valve 46 and pressure relief porting 48 are also within hot section 14. The boundaries of hot section 14 may be defined, for example, by a heated block of metal that is provided with porting to connect the inlets and outlets of the components of system 10. Pump 32 is driven by motor 36, which is an air motor connected to air hose 35C. Air hose 35E connects to pressure relief valve 46. Air hose 35D connects to module 42. Air hoses 35C-35E may all receive pressurized air from air source 16 (FIG. 1). Pressure relief porting 48 allows liquefied adhesive to pass from outlet 320 to inlet 321 when pressure relief valve 46 is open. Due to pressure lock, pressure relief valve 46 may be located anywhere along pressure relief porting 48.

During normal operation of system 10, pressure relief valve 46 is closed and hot melt adhesive from melter 30 is routed to module 40 for dispensing. As discussed with reference to FIG. 1, liquefied hot melt adhesive from melter 30 is drawn into inlet 321 of pump 32 through passage 31. Pump 32 pumps liquefied adhesive under pressure through outlet 320 of pump 32 and through passage 33 towards dispenser 34. Although passages 31, 33, and 48 are shown as extending between components of system 10 as separate hoses or lines, as mentioned, passages 31 and 33 may be formed integrally within housings of the components of system 10.

When pressurized air is not supplied through air hose 35C and 35E, as during shut down of system 10, motor 36 ceases to run, causing pump 32 to stop. Further, when insufficient pressurized air is supplied to air hose 35E to actuate valve 46, adhesive may be rerouted through pressure relief porting 48 from outlet 320 to inlet 321 until the pressure on each side of pump 32 is the same. For example, pressure relief valve 46 may include a valve spring which compresses to close porting 48 when pressurized air is applied and decompresses to open porting 48 when pressurized air is not applied. When system 10 is restarted, solidified adhesive in hot section 14 is re-liquefied, and the liquefied adhesive that was rerouted through pressure relief porting 48 at shutdown is among the first adhesive that passes through pump 32 and is dispensed via dispenser 34. For example, adhesive rerouted through pressure relief porting 48 to passage 31 is drawn into pump inlet 321. Adhesive within porting 48 is unable to char due to insufficient quantities of oxygen. Additionally, various flow control devices, such as orifices and restrictions, may be used to control flow between pressure relief porting 48 and passages 31 and 33. Thus, the char associated with additional recycling through the system is eliminated.

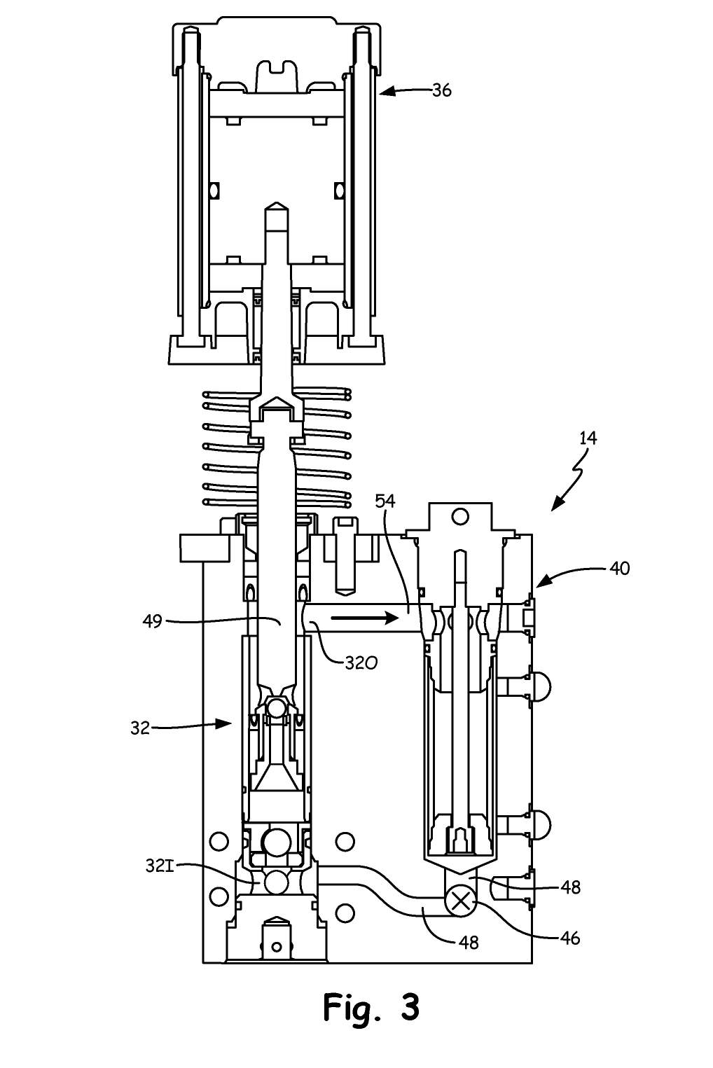

FIG. 3 shows a cross-section of the hot melt system described in FIGS. 1 and 2, showing plumbing of hot section 14. Pump 32 is a piston pump driven by motor 36 via pump rod 49. Motor 36 as shown in FIG. 3 is an air motor. Pressurized, liquefied adhesive passes from pump 32 through pump manifold block 52 toward manifold outlets 50, which may be connected to hoses 38, manifold 40, and dispensing modules 42 (FIG. 1). A schematic cross-section of pressure relief porting 48 is also shown. FIG. 3 shows pump inlet 321 and passage 33, as well as pressure relief porting 48, passing through a block. Machining these features into a block or other heated object facilitates keeping liquefied adhesive hot during operation, and during rerouting of liquefied adhesive at shutdown. During operation, liquefied adhesive flows from pump 32 to manifold 40 through passage 33 in pump manifold block 52. In some embodiments, pressure relief valve 46 may be closed using a valve stem (not shown) that extends into pressure relief porting 48 to prevent flow through porting 48. At shutdown, valve stem 59 of pressure relief valve 46 retracts from porting 48 and liquefied adhesive downstream of pump 32 in hot section 14 is rerouted to inlet 321 of pump 32 through pressure relief porting 48. Thus, rerouted adhesive is among the first adhesive to be used when system 10 is restarted and valve 46 is closed, and the rerouted adhesive does not go through as many heating cycles as are possible when rerouting sends the adhesive back to a tank. This reduction in heating cycles causes the adhesive to char less.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A hot melt system comprising:
a container for storing hot melt pellets;
a melter capable of heating hot melt pellets into a liquid;
a feed system for transporting hot melt pellets from the container to the melter;
a dispensing system for administering the liquid;
a pump for pressurizing the liquid between the melter and the dispensing system, the pump including:
an inlet operatively connected to the melter; and
an outlet operatively connected to the dispensing system; and
a pressure relief system capable of rerouting liquefied adhesive from the pump outlet to the pump inlet.

2. The hot melt system of claim 1, further comprising an air motor that powers the pump.

3. The hot melt system of claim 1, and further comprising a pressure relief valve in the pressure relief system, the pressure relief valve capable of being opened or closed to selectively allow liquefied adhesive to pass through a pressure relief porting.

4. The hot melt system of claim 3, wherein the pressure relief valve is kept closed when pressurized air is being supplied to an air motor.

5. The hot melt system of claim 1, wherein the pressure relief system includes pressure relief porting connected to the pump inlet at a first end and connected to the pump outlet at a second end.

6. The hot melt system of claim 1, wherein the pump outlet is connected to the dispensing system with a flexible hose.

7. The hot melt system of claim 1, wherein the pump outlet and the pressure relief system are directly connected to the dispensing system.

8. The hot melt system of claim 7, wherein the pump, the pressure relief system, and the dispensing system are all contained within an integrated block.

9. A method for reducing char in a hot melt system, the method comprising:
liquefying a solid adhesive in a melter at a first pressure;
pumping the liquefied adhesive to a dispensing system at a second pressure, using a pump having an inlet and an outlet;
dispensing adhesive from the dispensing system;
turning off the dispensing system and the pump; and
opening a pressure relief valve to connect the inlet of the pump and the outlet of the pump.

10. The method of claim 9, wherein opening the pressure relief includes turning off the dispensing system and the pump.

11. The method of claim 9, wherein the second pressure is higher than the first pressure.

12. The method of claim 9, wherein liquefying the solid adhesive includes heating the solid adhesive.

13. The method of claim 9, wherein the solid adhesive is a plurality of pellets.

14. The method of claim 9, wherein pumping the liquefied adhesive to the dispensing system at the second pressure includes driving the pump with an air motor.

15. The method of claim 14, wherein opening the pressure relief valve is in response to a reduction of air pressure applied to an air input on the pressure relief valve.

16. The method of claim 15, wherein the air pressure applied to the pressure relief valve is reduced to ambient pressure.

17. The method of claim 15, wherein the pressure relief valve and the air motor both receive pressurized air from a common pressurized air source.

18. The method of claim 9, wherein opening the pressure relief valve causes the liquefied adhesive to flow from the outlet to the inlet of the pump until the first pressure is the same as the second pressure.

19. The method of claim 18, further comprising:
turning on the dispense system and the pump; and
closing the pressure relief valve such that the adhesive which flowed through the pressure relief porting passes through the pump simultaneously with subsequently liquefied solid adhesive.

20. The method of claim 19, wherein closing the pressure relief valve includes turning on the dispense system and the pump.
